(19) United States
(12) Patent Application Publication
(10) Pub. No.: US 2026/0118721 A1
(43) Pub. Date: Apr. 30, 2026

(54) LIQUID CRYSTAL DEVICE AND ELECTRONIC APPARATUS

(71) Applicant: SEIKO EPSON CORPORATION, Tokyo (JP)

(72) Inventors: Kazu KOBAYASHI, KAI-SHI (JP); Mitsuhiro HORIKAWA, SUWA-SHI (JP); Satoshi YATABE, SHIOJIRI-SHI (JP); Yohei SUGIMOTO, FUJIMI-MACHI (JP); Daisuke MIYAWAKI, CHITOSE-SHI (JP); Hiroyuki OIKAWA, CHITOSE-SHI (JP)

(73) Assignee: SEIKO EPSON CORPORATION, Tokyo (JP)

(21) Appl. No.: 19/372,247

(22) Filed: Oct. 28, 2025

(30) Foreign Application Priority Data
Oct. 30, 2024 (JP) 2024-190960

(51) Int. Cl. G02F 1/1343; G02F 1/1339; G03B 21/00

(52) U.S. Cl. CPC G02F 1/13439; G02F 1/1339; G03B 21/006

(57) ABSTRACT

A liquid crystal device includes: a common electrode to which a common potential is applied, a pixel electrode disposed in a display region, a first electrode to which a first potential having a negative polarity with respect to the common potential is applied and which is disposed outside the display region, a second electrode to which a second potential having a positive polarity with respect to the common potential is applied and which is disposed outside the display region, a third electrode to which a third potential different from the common potential is applied and which is disposed outside the display region, and a liquid crystal layer disposed between the pixel electrode and the common electrode, between the first electrode and the common electrode, between the second electrode and the common electrode, and between the third electrode and the common electrode.

The present application is based on, and claims priority from JP Application Serial Number 2024-190960, filed Oct. 30, 2024, the disclosure of which is hereby incorporated by reference herein in its entirety.

### BACKGROUND

### 1. Technical Field

The present disclosure relates to a liquid crystal device and an electronic apparatus.

### 2. Related Art

A liquid crystal device is provided with a liquid crystal panel in which a liquid crystal layer is interposed between a pair of substrates. When light is incident on such a liquid crystal device, a liquid crystal material, an alignment film, or the like forming the liquid crystal panel reacts photochemically with the incident light, and ionic impurities may be generated as a reaction product. In addition, it is known that ionic impurities also diffuse into the liquid crystal layer from sealing material, a sealant, or the like, in the manufacturing process of the liquid crystal panel. These impurities may move within the display region along the oblique direction of the vapor-deposited film, which is deposited obliquely on the substrate, and accumulate at the corner portions of the display region in plan view, thereby forming display spots. The display quality of the liquid crystal device may deteriorate due to impurities moving in the display region or impurities accumulated in the corner portion of the display region.

In related art, measures for suppressing deterioration in the display quality of the liquid crystal device and improving reliability by capturing the impurities generated in the display region in a peripheral region outside the display region have been studied. For example, in the liquid crystal device disclosed in JP-A-2018-180428, a fixed potential different from the counter electrode potential applied to the counter electrode is applied to a first peripheral electrode disposed in the peripheral region around the first corner portion disposed diagonally along a direction intersecting one axial direction in the pixel region among peripheral electrodes disposed in the peripheral region around the pixel region in which a plurality of pixel electrodes are disposed. In the liquid crystal device disclosed in JP-A-2018-180428, a fixed potential smaller than the fixed potential applied to the first peripheral electrode may be applied to a second peripheral electrode disposed in the peripheral region around the second corner portion disposed diagonally along the one axial direction.

JP-A-2018-180428 is an example of the related art.

It has been confirmed that the impurities present in the display region, as described above, are formed from ionic substances and contain impurities having a positive polarity and impurities having a negative polarity. In the liquid crystal device disclosed in JP-A-2018-180428, even when a fixed potential corresponding to impurities having one of the positive polarity and the negative polarity is applied to the first peripheral electrode and the second peripheral electrode, the amount of impurities captured in the display region is insufficient, the deterioration of display quality cannot be suppressed, and the reliability may deteriorate. Therefore, it is desired to take measures to remove the impurities from the display region based on the polarity of the impurities to enhance the display quality and reliability of the liquid crystal device.

### SUMMARY

A liquid crystal device according to an aspect of the present disclosure includes: a common electrode to which a common potential is applied, a pixel electrode, which is applied with a signal potential and disposed in a display region, a first electrode to which a first potential having a negative polarity with respect to the common potential is applied and which is disposed outside the display region in plan view, a second electrode to which a second potential having a positive polarity with respect to the common potential is applied and which is disposed outside the display region in plan view, a third electrode to which a third potential different from the common potential is applied and which is disposed outside the display region in plan view, and a liquid crystal layer disposed between the pixel electrode and the common electrode, between the first electrode and the common electrode, between the second electrode and the common electrode, and between the third electrode and the common electrode. In plan view, the distance between the third electrode and the display region is longer than a first distance between the first electrode and the display region and a second distance between the second electrode and the display region. In plan view, the first electrode is disposed between the third electrode and the display region, and the second electrode is disposed between the third electrode and the display region.

### BRIEF DESCRIPTION OF THE DRAWINGS

FIG. 1 is a plan view of a liquid crystal device according to a first embodiment.

FIG. 2 is a cross-sectional view of the liquid crystal device of FIG. 1 taken along line II-II.

FIG. 3 is a cross-sectional view of the liquid crystal device of FIG. 1 taken along line III-III.

FIG. 4 is an equivalent circuit diagram of a pixel circuit in a pixel region of the liquid crystal device of FIG. 1.

FIG. 5 is a cross-sectional view showing the behavior of impurities in the pixel region of the liquid crystal device of FIG. 1.

FIG. 6 is a cross-sectional view showing the behavior of impurities in the peripheral region of the liquid crystal device of FIG. 1.

FIG. 7 is a schematic diagram of a projector according to the first embodiment.

FIG. 8 is a cross-sectional view of a liquid crystal device according to a second embodiment.

FIG. 9 is another cross-sectional view of the liquid crystal device according to the second embodiment.

FIG. 10 is a cross-sectional view of a liquid crystal device according to a third embodiment.

FIG. 11 is another cross-sectional view of the liquid crystal device according to the third embodiment.

### DESCRIPTION OF EMBODIMENTS

Hereinafter, a liquid crystal device will be described as an example of an electro-optical device according to the embodiment. In the following drawings, dimensions and scales of parts are appropriately different from those of an actual device. The embodiments described below are preferred specific examples. Unless otherwise stated in the following description, the scope of the present disclosure is not limited to the embodiments described below.

### First Embodiment

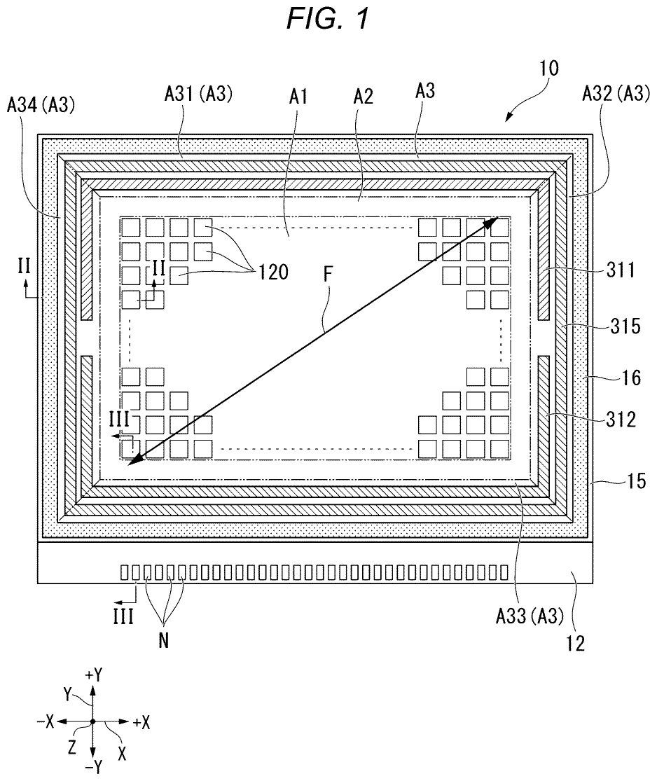

A first embodiment of the present disclosure will first be described with reference to FIGS. 1 to 7.

### Liquid Crystal Device

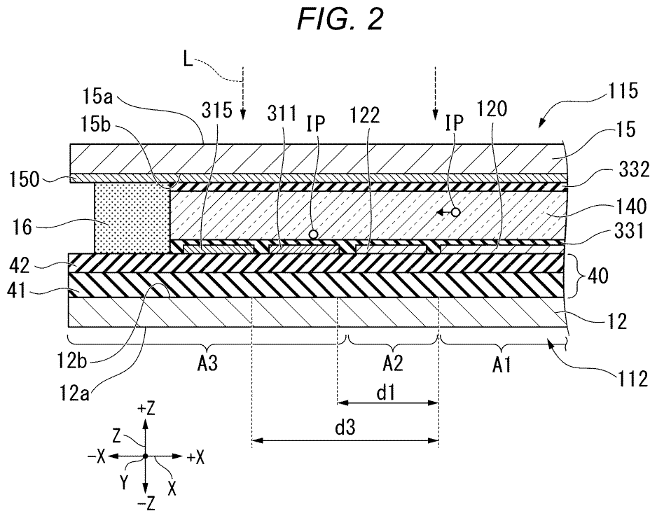

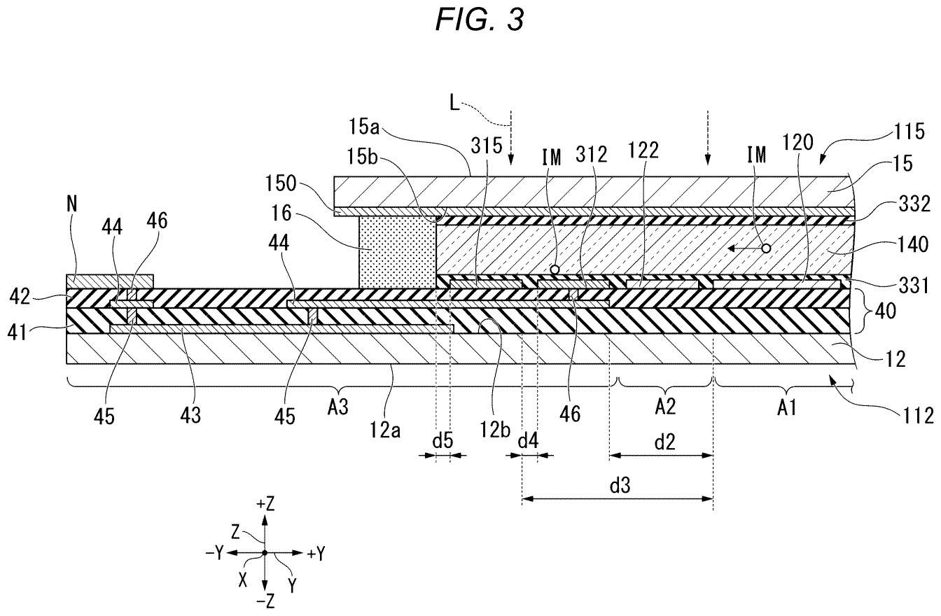

The liquid crystal device 10 according to the first embodiment is an electro-optical device and a liquid crystal display device including a liquid crystal element that converts incident color light into image light. FIG. 1 is a plan view of the liquid crystal device 10. FIG. 2 is a cross-sectional view of the liquid crystal device 10 of FIG. 1 taken along line II-II. FIG. 3 is a cross-sectional view of the liquid crystal device 10 of FIG. 1 taken along line III-III.

As illustrated in FIGS. 1 to 3, the liquid crystal device 10 includes a first substrate 112, a second substrate 115, a liquid crystal layer 140, and a sealing material 16. The first substrate 112 includes an element substrate 12, a plurality of pixel electrodes 120, a plurality of dummy pixel electrodes 122, a first peripheral electrode 311, a second peripheral electrode 312, a third peripheral electrode 315, a plurality of terminals N, and an alignment film 331. The second substrate 115 includes a counter substrate 15, a counter electrode 150, and an alignment film 332.

The element substrate 12 has a rectangular shape in plan view, for example, an oblong shape, and has plate surfaces 12a and 12b. The counter substrate 15 has a rectangular shape in plan view, for example, an oblong shape, and has plate surfaces 15a and 15b. The long sides of the plate surfaces 15a and 15b of the counter substrate 15 have the same length as the long sides of the plate surfaces 12a and 12b of the element substrate 12. The short sides of the plate surfaces 15a and 15b of the counter substrate 15 are shorter than the short sides of the plate surfaces 12a and 12b of the element substrate 12.

In the following description and the drawings, the X direction is one direction within the plate surfaces 12a of the element substrate 12 and 15a of the counter substrate 15, and is, for example, a direction parallel to the long side directions of the plate surfaces 12a and 15a. One side along the X direction is described as a +X side, and the other side along the X direction is described as a −X side. The Y direction is orthogonal to the X direction, is one direction within the plate surface 12a of the element substrate 12 and the plate surface 15a of the counter substrate 15, and is, for example, a direction parallel to the short side directions of the plate surface 12a and the plate surface 15a. One side along the Y direction is described as a +Y side, and the other side along the Y direction is described as a −Y side. The Z direction is orthogonal to the X direction and the Y direction, and is parallel to, for example, a direction along the thicknesses of the element substrate 12 and the counter substrate 15. One side along the Z direction is described as a +Z side, and the other side along the Z direction is described as a −Z side. The plan view means viewing along the Z direction.

The plate surface 12b of the element substrate 12 is parallel to the XY plane including the X direction and the Y direction, and is a plate surface on the +Z side among the plate surfaces 12a and 12b. A scanning line driving circuit, a data signal output circuit, a transistor functioning as a switching element, and the like (not illustrated) are formed on the element substrate 12. A wiring layer 40 is formed on the plate surface 12a of the element substrate 12. In the wiring layer 40, a first wiring layer 43, a first insulating layer 41, a first contact plug 45, a second wiring layer 44, a second insulating layer 42, and a second contact plug 46 are stacked in this order in the Z direction from the element substrate 12 side, that is, the −Z side.

The plate surface 15b of the counter substrate 15 is parallel to the XY plane and is a plate surface on the −Z side among the plate surfaces 15a and 15b. In the liquid crystal device 10, the plate surface 12b of the element substrate 12 and the plate surface 15b of the counter substrate 15 face each other in the Z direction, and the first substrate 112 and the second substrate 115 are separated from each other at an appropriate interval. In the liquid crystal device 10, the first substrate 112 and the second substrate 115 are bonded to each other via the sealing material 16 such that the distance between the plate surface 12a of the element substrate 12 and the plate surface 15a of the counter substrate 15 in the Z direction, that is, the entire thickness in the Z direction is substantially constant.

In plan view, the liquid crystal device 10 is partitioned into a pixel region A1 including the center in the XY plane, a dummy pixel region A2 surrounding the pixel region A1 and located outside the pixel region A1, and a peripheral region A3 surrounding the dummy pixel region A2 and located further outside the dummy pixel region A2. The pixel region A1 corresponds to a display region described later and a display region of a liquid crystal device described in the claims.

The plurality of pixel electrodes 120, the plurality of dummy pixel electrodes 122, the first peripheral electrode 311, the second peripheral electrode 312, and the third peripheral electrode 315 are formed in the wiring layer 40. The plurality of pixel electrodes 120 are disposed in the pixel region A1, and are disposed in a matrix pattern at appropriate intervals along the X direction and the Y direction in the pixel region A1.

The plurality of dummy pixel electrodes 122 are disposed in the dummy pixel region A2. The dummy pixel region A2 is partitioned in a frame shape in plan view. The plurality of dummy pixel electrodes 122 have the same shape and size as the plurality of pixel electrodes 120 in plan view, and are disposed in a matrix pattern at appropriate intervals in the same manner as the plurality of pixel electrodes 120 along the X direction and the Y direction. In FIG. 1, the plurality of dummy pixel electrodes 122 are omitted.

In the liquid crystal device 10, since the dummy pixel region A2 is partitioned and the plurality of dummy pixel electrodes 122 are disposed in the dummy pixel region A2, there is no difference in the electrode structure and the relative arrangement in the vicinity of the boundary between the pixel region A1 and the dummy pixel region A2, and the occurrence of display unevenness and deterioration of display quality in the outer peripheral end portion of the pixel region A1 in plan view is suppressed. In other words, when the plurality of dummy pixel electrodes 122 having the same shape and size as the plurality of pixel electrodes 120 in plan view are not present at all for the dummy pixel electrode 122, the electrode structure and the relative arrangement may suddenly change in the vicinity of the boundary between the pixel region A1 and the dummy pixel region A2, and display unevenness may occur at the outer peripheral end portion of the pixel region A1 in plan view, or display quality may deteriorate.

When the influence of the deterioration of the display quality described above is small, the dummy pixel region A2 may be omitted, and a region corresponding to the dummy pixel region A2 may be within the pixel region A1.

The first peripheral electrode 311 is disposed in the peripheral region A3. The peripheral region A3 is partitioned into a frame shape in plan view, and includes a region A31 on the +Y side parallel to the X direction, a region A32 on the +X side parallel to the Y direction, a region A33 on the −Y side parallel to the X direction, and a region A34 on the −X side parallel to the Y direction. The first peripheral electrode 311 corresponds to a first electrode described later and a first electrode of a liquid crystal device described in the claims. For example, the first peripheral electrode 311 extends along the X direction in the region A31 of the peripheral region A3, and extends along the Y direction in portions on the +Y side relative to the center in the Y direction in the regions A32 and A34 of the peripheral region A3.

The second peripheral electrode 312 is disposed in the peripheral region A3. The second peripheral electrode 312 corresponds to a second electrode described later and a second electrode of the liquid crystal device described in the claims. For example, the second peripheral electrode 312 extends along the X direction in the region A33 of the peripheral region A3, and extends along the Y direction in portions on the −Y side relative to the center in the Y direction in the regions A32 and A34 of the peripheral region A3.

The third peripheral electrode 315 is disposed in the peripheral region A3, and, in plan view, is disposed at least outside the first peripheral electrode 311 and the second peripheral electrode 312, and is disposed inside the sealing material 16. The third peripheral electrode 315 corresponds to a third electrode described later and a third electrode of the liquid crystal device described in the claims.

The third peripheral electrode 315 extends, for example, over the entire circumference of the peripheral region A3, that is, is disposed in a frame shape in plan view. The second peripheral electrode 312 is not electrically coupled to the first peripheral electrode 311. The detailed relative arrangement and the like of the first peripheral electrode 311, the second peripheral electrode 312, and the third peripheral electrode 315 will be described later.

The pixel electrode 120, the dummy pixel electrode 122, the first peripheral electrode 311, the second peripheral electrode 312, and the third peripheral electrode 315 are made of a transparent conductive material that transmits the color light L in the visible wavelength band incident from the +Z side, and are formed of, for example, indium tin oxide (ITO) formed by the same process.

The counter electrode 150 is formed on the entire plate surface 15b of the counter substrate 15. The counter electrode 150 is made of a transparent conductive material corresponding to light incident from the +Z side, and is formed of, for example, ITO.

The first substrate 112 and the second substrate 115 are bonded to each other in the Z direction as described above, and the portion of the first substrate 112 on the −Y side of the element substrate 12 extends further to the −Y side than the counter substrate 15. The plurality of terminals N are formed on the plate surface 12b of the element substrate 12 extending further to the −Y side than the counter substrate 15. The plurality of terminals N input various electric signals to the scanning line driving circuit and the data signal output circuit.

The alignment films 331 and 332 are disposed in the pixel region A1, the dummy pixel region A2, and the peripheral region A3 on the inner peripheral side of the sealing material 16 in plan view. The alignment film 331 covers, from the +Z side, each of the following: the plurality of pixel electrodes 120, the plurality of dummy pixel electrodes 122, the first peripheral electrode 311, the second peripheral electrode 312, and the plate surface 12b of the element substrate 12 on which no electrode is formed. The +Z side surface of the alignment film 331 is parallel to the XY plane and is substantially flat.

The alignment film 332 is formed on the −Z side surface of the counter electrode 150 and covers the counter electrode 150 from the −Z side. The −Z side surface of the alignment film 332 is parallel to the XY plane and is substantially flat. The alignment films 331 and 332 determine the alignment of the liquid crystal molecules within the liquid crystal layer 140, and, for example, incline them slightly at an angle with respect to the Z direction in a non-applied potential state.

The dummy pixel region A2 and the peripheral region A3 do not contribute to image display. For example, a light-shielding film (not illustrated) may be formed on the plate surface 15a of the counter substrate 15 in the dummy pixel region A2 and the peripheral region A3.

The liquid crystal layer 140 is disposed between the plate surface 12a of the element substrate 12 and the plate surface 15a of the counter substrate 15, and is interposed, in the Z direction, between the plurality of pixel electrodes 120, the plurality of dummy pixel electrodes 122, the first peripheral electrode 311, and the second peripheral electrode 312, and the counter electrode 150. Specifically, the liquid crystal layer 140 is sandwiched between the alignment films 331 and 332 in the Z direction.

The liquid crystal layer 140 is surrounded by the sealing material 16 in plan view, and is sealed by the sealing material 16 in the XY plane. The liquid crystal layer 140 is a layer formed of liquid crystal molecules whose major axis direction is substantially parallel to the Z direction in a non-applied potential state, for example, as in a vertical alignment (VA) mode.

The sealing material 16 is disposed in the peripheral region A3, is disposed at least outside the third peripheral electrode 315, and is preferably disposed in the outermost peripheral region of the peripheral region A3. The sealing material 16 corresponds to a sealant described later and a sealant described in the claims. The material of the sealing material 16 is, for example, an ultraviolet curing type or thermosetting type epoxy resin or acrylic resin. In addition, the impurities IS described later may, for example, elute from additives or the like when the material of the sealing material 16 described above is insufficiently cured in the manufacturing process of the liquid crystal device 10.

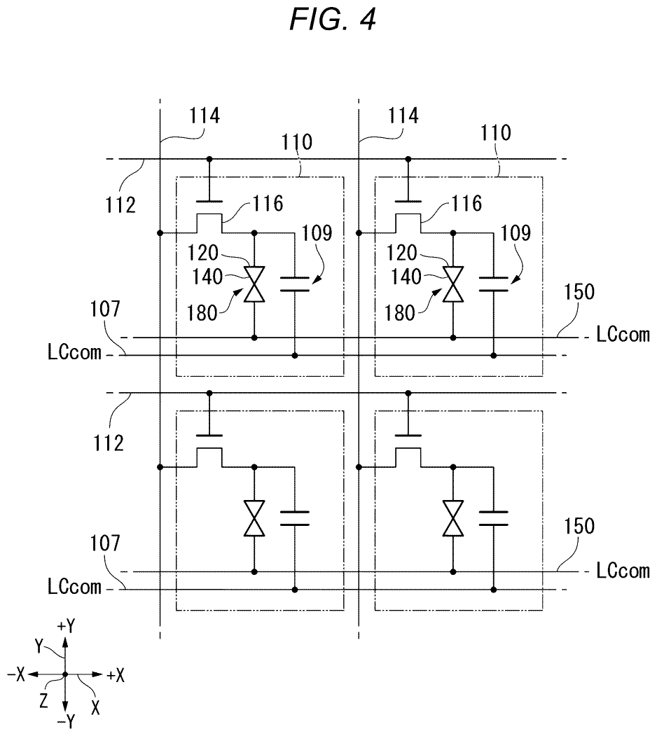

FIG. 4 is an equivalent circuit diagram of the pixel circuit 110 configured in the pixel region A1. As illustrated in FIG. 4, the pixel circuit 110 is provided corresponding to intersection positions of a plurality of scanning lines 113 extending in the X direction and a plurality of data lines 114 extending in the Y direction. The pixel circuit 110 includes a transistor 116 functioning as a switching element and a liquid crystal element 180.

The transistor 116 is, for example, an N-channel thin film transistor (TFT). In the pixel circuit 110, the gate node of the transistor 116 is coupled to the scanning line 113, the source node of the transistor 116 is coupled to the data line 114, and the drain node of the transistor 116 is coupled to the pixel electrode 120.

In the description in the present specification, “coupling” means direct or indirect coupling or bonding between two or more elements. In the description in this specification, “coupled” includes, for example, a state in which two or more elements are coupled to each other on a substrate and a state in which two or more elements are bonded to each other via different conductive layers and contact plugs.

The counter electrode 150 faces the plurality of pixel electrodes 120 and is maintained at a substantially constant potential LCcom over time. A predetermined potential LCsig different from the potential LCcom is applied to each of the plurality of pixel electrodes 120. The potential LCcom corresponds to a common potential described later and a common potential in the liquid crystal device described in the claims. The potential LCsig corresponds to a signal potential described later and a signal potential in the liquid crystal device described in the claims. In each of the plurality of pixel circuits 110, the liquid crystal element 180 is formed by the pixel electrode 120, the counter electrode 150, and the liquid crystal layer 140.

A storage capacitor 109 is provided electrically in parallel with the liquid crystal element 180. One end of the storage capacitor 109 is coupled to the pixel electrode 120, and the other end of the storage capacitor 109 is coupled to a capacitance line 107. The capacitance line 107 is maintained at a constant potential over time, for example, the same potential LCcom as the counter electrode 150.

The scanning line driving circuit sequentially and exclusively selects the plurality of scanning lines 113 one by one in one frame period, and sets the scanning signal of the selected scanning line 113 to a relatively high H level. The data signal output circuit outputs a data signal having a potential corresponding to a gradation to the pixel circuit 110 located on the scanning line 113 selected by the scanning line driving circuit via the data line 114.

In the pixel circuit 110 corresponding to the scanning line 113 in which the scanning signal is at the H level, since the transistor 116 enters the on state, the data signal is applied to the pixel electrode 120 via the data line 114. Even when the scanning signal becomes a relatively low L level and the transistor 116 enters the off state, the data signal is held by the capacitance of the liquid crystal element 180 and the storage capacitor 109.

In the liquid crystal element 180, the orientation of the liquid crystal molecules changes in accordance with an electric field generated by the pixel electrode 120 and the counter electrode 150.

The above-described operation and behavior are similarly executed in the pixel circuit 110 coupled to the selected scanning line 113. By sequentially and exclusively selecting the scanning lines 113 in one frame period, the alignment directions of all the liquid crystal elements 180 in the pixel region A1 change according to the gradation. As a result, an image in one frame period is generated, and the color light L is converted into image light (not illustrated).

The liquid crystal element 180 operates in a normally black mode, for example. In the normally black mode, when the applied potential to the liquid crystal element 180 is zero, the transmittance of light passing through the liquid crystal element 180 and then through the polarizing plate (not illustrated) is at its lowest, and as the applied potential increases, the transmittance of light passing through the liquid crystal element 180 and then through the polarizing plate (not illustrated) increases.

The liquid crystal element 180 is driven by direct current or alternating current. Specifically, when the liquid crystal element 180 is driven by alternating current, the potential of the data signal is a potential having a positive polarity on the higher side or a potential having a negative polarity on the lower side with respect to the potential LCcom of the counter electrode 150, and is alternately switched between the potential having a positive polarity and the potential having a negative polarity, for example, for each frame period.

The first peripheral electrode 311 is maintained at a potential LC1 different from the potential LCcom of the counter electrode 150. The potential LC1 has a negative polarity with respect to the potential LCcom. The potential LC1 corresponds to a first potential described later, and corresponds to a first potential in the liquid crystal device described in the claims. The potential LC1 is applied to the first peripheral electrode 311 from, for example, a common wiring (not illustrated) which is not electrically coupled to each of the scanning line 113 and the data line 114 in the first substrate 112.

The second peripheral electrode 312 is maintained at a potential LC2 different from the potential LCcom of the counter electrode 150 and the potential LC1 of the first peripheral electrode 311. The potential LC2 has a positive polarity with respect to the potential LCcom. The potential LC2 corresponds to a second potential described later, and corresponds to a second potential in the liquid crystal device described in the claims.

The potential LC2 is applied to the second peripheral electrode 312 from, for example, another common wiring (not illustrated), which is not electrically coupled to each of the scanning line 113, the data line 114, and the common wiring which applies the potential LC1 to the first peripheral electrode 311 in the first substrate 112.

The third peripheral electrode 315 is maintained at a potential LC3 different from the potential LCcom of the counter electrode 150. The potential LC3 has an appropriate polarity with respect to the potential LCcom in accordance with the polarity of the impurities IS generated from the sealing material 16. For example, the potential LC3 may be approximately the same as the potential LC1 of the first peripheral electrode 311 as long as the impurities IS have a negative polarity. The potential LC3 corresponds to a third potential described later, and corresponds to a third potential in the liquid crystal device described in the claims.

The potential LC3 is applied to the third peripheral electrode 315 from, for example, another common wiring (not illustrated) which is not electrically coupled to each of the scanning line 113, the data line 114, the common wiring which applies the potential LC1 to the first peripheral electrode 311, and the common wiring which applies the potential LC2 to the second peripheral electrode 312 in the first substrate 112. However, when the potential LC3 of the third peripheral electrode 315 is approximately equal to either the potential LC1 of the first peripheral electrode 311 or the potential LC2 of the second peripheral electrode 312, the potential LC3 may be applied to the third peripheral electrode 315 from the common wiring that applies a potential to either of the electrodes described above.

As illustrated in FIG. 2, the distance d1 between the first peripheral electrode 311 and the pixel electrode 120 of the pixel region A1 corresponds to a first distance described later and a first distance in the liquid crystal device described in the claims. The distance d1 is in the XY plane substantially constant, but is not necessarily constant, and for example, the distance d1 between the first peripheral electrode 311 in the regions A32 and A34 of the peripheral region A3 and the pixel electrode 120 may be longer than the distance between the first peripheral electrode 311 in the region A31 and the pixel electrode 120. Strictly speaking, the distance between the first peripheral electrode 311 and the pixel region A1, and the first distance, are the shortest distance, in the XY plane, between the inner peripheral end of the first peripheral electrode 311 and the end of one pixel electrode 120 disposed on the outer peripheral side among the plurality of pixel electrodes 120, facing the first peripheral electrode 311.

The distance d3 between the third peripheral electrode 315 and the pixel electrode 120 in the pixel region A1 is substantially constant in the XY plane, but is not necessarily constant, and for example, the distance d3 between the third peripheral electrode 315 in the regions A32 and A34 in the peripheral region A3 and the pixel electrode 120 may be longer than the distance between the third peripheral electrode 315 in the regions A31 and A33 and the pixel electrode 120. Strictly speaking, the distance between the third peripheral electrode 315 and the pixel region A1 is the shortest distance, in the XY plane, between the inner peripheral end of the second peripheral electrode 312 and the outer peripheral end of one pixel electrode 120 disposed on the outer peripheral side among the plurality of pixel electrodes 120, facing the third peripheral electrode 315.

In the liquid crystal device 10 according to the first embodiment, the distance d3 is longer than the distance d1. That is, the distance between the third peripheral electrode 315 and the pixel region A1 is at least longer than the distance between the first peripheral electrode 311 and the pixel region A1. As will be described later, the ratio between the distance d1 and the distance d3 is appropriately set according to the ratio between the moving speed of the impurities IP generated in the pixel region A1 and formed from ionic substances having a positive polarity and the moving speed of the impurities IS generated from the sealing material 16 and formed from ionic substances having a negative polarity, the ratio between the diffusion speeds of the impurities IP and IS, the ratio between the impurities IP and IS repelled by the third peripheral electrode 315, and the like.

When an appropriate potential is applied to each electrode of the liquid crystal device 10, the color light L is incident from the +Z side of the plate surface 15a of the counter substrate 15 of the second substrate 115 in the pixel region A1 along the Z direction, and the conversion of the color light L into the image light proceeds, impurities IM and IP formed from ionic substances are generated in the liquid crystal layer 140. The impurities IM are formed from ionic substances having a negative polarity. The impurities IP are formed from ionic substances having a positive polarity. The impurities IP generated from the liquid crystal layer 140 in the pixel region A1 are captured by the first peripheral electrode 311 to which a negative potential is applied.

As illustrated in FIG. 3, the distance d2 between the second peripheral electrode 312 and the pixel electrode 120 of the pixel region A1 corresponds to a second distance described later and a second distance in the liquid crystal device described in the claims. The distance d2 in the XY plane is substantially constant, but is not necessarily constant, and for example, the distance d2 between the second peripheral electrode 312 in the regions A32 and A34 of the peripheral region A3 and the pixel electrode 120 may be longer than the distance between the second peripheral electrode 312 in the region A33 and the pixel electrode 120. Strictly speaking, the distance between the second peripheral electrode 312 and the pixel region A1, and the second distance, are the shortest distance, in the XY plane, between the inner peripheral end of the second peripheral electrode 312 and the outer peripheral end of one pixel electrode 120 disposed on the outer peripheral side among the plurality of pixel electrodes 120, facing the second peripheral electrode 312.

As illustrated in FIG. 3, the first insulating layer 41 is provided between the first wiring layer 43 and the second wiring layer 44 in the Z direction, and includes the first contact plug 45. The first contact plug 45 is disposed to electrically couple the first wiring layer 43 and the second wiring layer 44. The second insulating layer 42 is provided between the second wiring layer 44 and each of the first peripheral electrode 311, the second peripheral electrode 312, the third peripheral electrode 315, and the pixel electrode 120, and includes the second contact plug 46. The second contact plug 46 is disposed to electrically couple the second wiring layer 44 to one of the first peripheral electrode 311, the second peripheral electrode 312, the third peripheral electrode 315, or the pixel electrode 120.

The second peripheral electrode 312 is electrically coupled to the terminal N via the first insulating layer 41, the second insulating layer 42, the first wiring layer 43, the second wiring layer 44, the first contact plug 45, and the second contact plug 46. Similarly to the second peripheral electrode 312, the first peripheral electrode 311 and the third peripheral electrode 315 are electrically coupled to the terminal N via the first insulating layer 41, the second insulating layer 42, the first wiring layer 43, the second wiring layer 44, the first contact plug 45, and the second contact plug 46.

In plan view, the distance d4 between the second peripheral electrode 312 and the third peripheral electrode 315 and the distance d5 between the third peripheral electrode 315 and the sealing material 16 may be different from each other. For example, the distance d5 may be shorter than the distance d4. The first contact plug 45 that electrically couples any one of the first peripheral electrode 311, the second peripheral electrode 312, and the third peripheral electrode 315 to the terminal N is disposed outside the sealing material 16 in plan view.

In the liquid crystal device 10 according to the first embodiment, the distance d2 is equal to the distance d1. The distance d3 is longer than the distance d2. That is, the distance between the third peripheral electrode 315 and the pixel region A1 is at least longer than the distance between the second peripheral electrode 312 and the pixel region A1. The ratio between the distance d2 and the distance d3 is appropriately set according to the ratio between the moving speed of the impurities IM generated in the pixel region A1 and having a negative polarity and the moving speed of the impurities IS formed from ionic substances generated from the sealing material 16, the ratio between the diffusion speeds of the impurities IM and IS, the ratio between the impurities IM and IS repelled by the third peripheral electrode 315, and the like.

The impurities IM generated from the liquid crystal layer 140 in the pixel region A1 are formed from ionic substances having a negative polarity, and are captured by the second peripheral electrode 312 to which a positive potential is applied. The sealing material 16 also generates the impurities IS formed from ionic substances having a negative polarity. A repulsive force is exerted from the third peripheral electrode 315, to which a negative potential is applied, against the impurities IS approaching the third peripheral electrode 315 from the sealing material 16 in the peripheral region A3. That is, the third peripheral electrode 315 repels the impurities IS.

In the liquid crystal device 10, the impurities IP generated in the liquid crystal layer 140 in the pixel region A1 are captured by the first peripheral electrode 311 in the energized state, and the impurities IM generated in the liquid crystal layer 140 in the pixel region A1 are captured by the second peripheral electrode 312 in the energized state. The impurities IS generated outside the third peripheral electrode 315 including the sealing material 16 are repelled toward the outside of the third peripheral electrode 315 by the third peripheral electrode 315. From these points, display spots and the like are prevented from being formed on the outer peripheral end of the pixel region A1. As a result, the display quality and reliability of the liquid crystal device 10 are improved.

Each of the potentials LC1, LC2 and LC3 is a direct-current potential or an alternating-current potential, and is preferably a direct-current potential. Since each of the potentials LC1, LC2 and LC3 is a direct-current potential, the capturing effect of the impurities IP in the first peripheral electrode 311 in the energized state, the capturing effect of the impurities IM in the second peripheral electrode 312 in the energized state, and the repulsive effect of the third peripheral electrode 315 on the impurities IS in the energized state are stabilized.

As an example, when the potential LCcom is +7.5V, the potential LC1 is set to +6.0V, the potential LC2 is set to +9.0V, and the potential LC3 is set to +6.0V. As another example, when the potential LCcom is +7.5V, the potential LC1 may be set to +6.0V, the potential LC2 may be set to +9.0V, and the potential LC3 may be set to +6.0V. In this case, the potential LC3 may be set to +6.5V, and the potential LC1 may be set to +6.5V. Further, as another example, when the potential LCcom is +7.5V, the potential LC1 may be set to +7.5V, the potential LC2 may be set to +9.0V, and the potential LC3 may be set to +6.0V.

However, when the potentials LC1 and LC2 are alternating-current potentials, and the negative polarity and the positive polarity of the potentials LC1 and LC2 with respect to the potential LCcom are alternately switched at a predetermined time cycle, the capturing effects of the first peripheral electrode 311 and the second peripheral electrode 312 in the energized state on the impurities IM and IP are alternately exhibited at the predetermined time cycle. This makes it possible to achieve both the capturing effect on the impurities IP and the capturing effect on the impurities IM by the first peripheral electrode 311 and the second peripheral electrode 312.

As an example, when the potential LCcom is +7.5V, the potential LC1 may be set to an alternating-current potential, the potential LC2 may be set to +9.0V, and the potential LC3 may be set to +6.0V. As another example, when the potential LCcom is +7.5V, an alternating-current potential may be applied to the potential LC1, an alternating-current potential may be applied to the potential LC2, and the potential LC3 may be set to +6.0V. In this case, the frequency of the alternating-current potential applied to the potential LC1 and the frequency of the alternating-current potential applied to the potential LC2 may be different from each other, and the frequency of the alternating-current potential applied to the potential LC2 may be lower than the frequency of the alternating-current potential applied to the potential LC1. When the potential LC1 is an alternating-current potential, the average value of the potential LC1 is 6V to 7V, and may be negative with respect to the potential LCcom. When the potential LC2 is an alternating-current potential, the average value of the potential LC2 is 8V to 9V, and may be positive with respect to the potential LCcom.

The first peripheral electrode 311 and the second peripheral electrode 312 are not electrically coupled to each other and are not coupled to each other in the XY plane. As illustrated in FIG. 1, for example, the first peripheral electrode 311 and the second peripheral electrode 312 are separated from each other, in plan view, at central portions in the Y direction of each of the regions A32 and A34, in the circumferential direction of the peripheral region A3.

As an example, the liquid crystal molecules of the liquid crystal layer 140 may be aligned, in a non-applied potential state, by the alignment films 331 and 332 in a direction from the −Y side to the +Y side as they move from the −X side to the +X side in the pixel region A1, that is, in an alignment direction F along a line coupling the vicinity of the corner portion on the −X side and −Y side of the pixel region A1 with the vicinity of the corner portion on the +X side and +Y side in plan view.

The alignment direction of the liquid crystal molecules in the liquid crystal layer 140 is determined by the ejection angle of the material of the alignment film 331 when the alignment film 331 is obliquely deposited on the +Z side surface of each of the plurality of pixel electrodes 120, the plurality of dummy pixel electrodes 122, the first peripheral electrode 311, and the second peripheral electrode 312, as well as on the plate surface 12b of the element substrate 12 on which each electrode is not formed, and by the ejection angle of the material of the alignment film 332 when the alignment film 332 is obliquely deposited on the −Z side surface of the counter electrode 150.

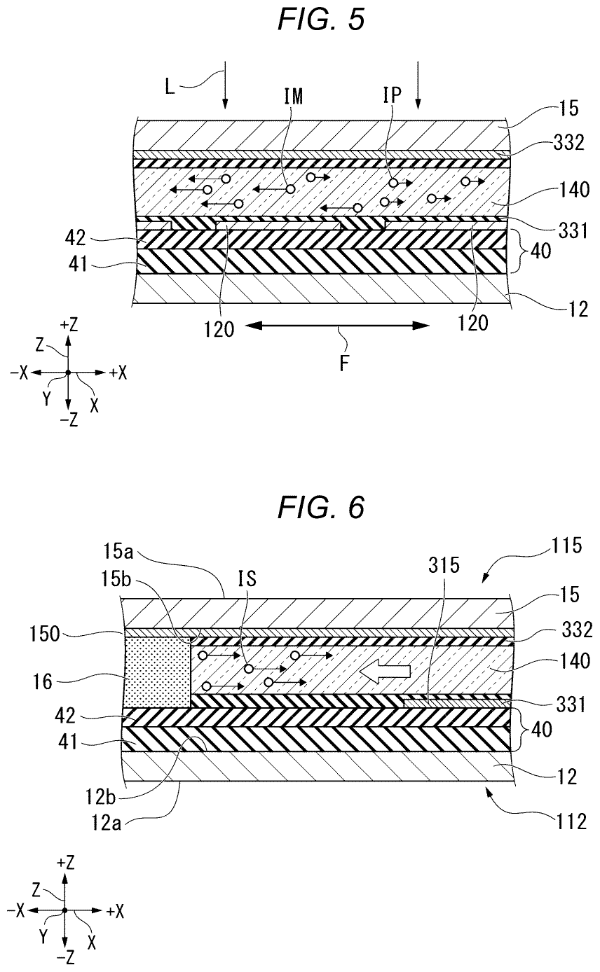

FIG. 5 is a cross-sectional view illustrating the movement of the impurities IM and IP when appropriate potentials are applied to each electrode of the liquid crystal device 10, when the liquid crystal molecules of the liquid crystal layer 140 are aligned along the alignment direction F. As illustrated in FIGS. 1 and 5, the impurities IP generated in the liquid crystal layer 140 of the pixel region A1 move to the corner portion on the +X side and the +Y side along the alignment direction F, accumulate toward the first peripheral electrode 311, pass through the dummy pixel region A2, and are captured by the first peripheral electrode 311 of the peripheral region A3 via the alignment film 331.

The impurities IM generated in the liquid crystal layer 140 of the pixel region A1 move to the corner portion on the −X side and the −Y side along the alignment direction F, accumulate toward the second peripheral electrode 312, pass through the dummy pixel region A2, and are captured by the second peripheral electrode 312 of the peripheral region A3 via the alignment film 331.

In plan view, the peripheral region A3 with respect to the corner portion on the +X side and the +Y side of the pixel region A1, that is, the first peripheral electrode 311 on the +X side end of the region A31 of the peripheral region A3 and the first peripheral electrode 311 on the +Y side end of the region A32 are coupled to each other. Therefore, when the liquid crystal molecules of the liquid crystal layer 140 are aligned along the alignment direction F, the impurities IP that move to the corner portion on the +X side and +Y side along the alignment direction F are efficiently and smoothly captured by the first peripheral electrode 311.

In plan view, the peripheral region A3 with respect to the corner portion on the −X side and the −Y side of the pixel region A1, that is, the second peripheral electrode 312 on the −X side end of the region A33 of the peripheral region A3 and the second peripheral electrode 312 on the −Y side end of the region A34 are coupled to each other. Therefore, when the liquid crystal molecules of the liquid crystal layer 140 are aligned along the alignment direction F, the impurities IM that move to the corner portion on the −X side and −Y side along the alignment direction F are efficiently and smoothly captured by the second peripheral electrode 312. As a result, it is possible to efficiently prevent the occurrence of display spots that have previously occurred in vicinity of the corner portion on the +X and +Y side, and in vicinity of the corner portion on the −X and −Y side of the pixel region A1.

Although not illustrated, the liquid crystal molecules of the liquid crystal layer 140 may be aligned in a direction intersecting the alignment direction F in plan view, for example, along a line connecting the vicinity of the corner portion on the −X side and +Y side of the pixel region A1 to the vicinity of the corner portion on the +X side and −Y side in plan view. Also in this case, as illustrated in FIG. 1, the peripheral region A3 with respect to the corner portion on the −X side and the +Y side of the pixel region A1, that is, the first peripheral electrode 311 on the −X side end of the region A31 of the peripheral region A3 and the first peripheral electrode 311 on the +Y side end of the region A34 are coupled to each other. Therefore, the impurities IP generated in the liquid crystal layer 140 and moving to the vicinity of the corner portion on the −X side and the +Y side are efficiently and smoothly captured by the first peripheral electrode 311.

Also in the above-described case, the peripheral region A3 with respect to the corner portion on the +X side and the −Y side of the pixel region A1, that is, the second peripheral electrode 312 on the +X side end of the region A33 of the peripheral region A3 and the second peripheral electrode 312 on the −Y side end of the region A32 are coupled to each other. Therefore, the impurities IM generated in the liquid crystal layer 140 and moving to the vicinity of the corner portion on the +X side and the −Y side are efficiently and smoothly captured by the second peripheral electrode 312.

As described above, when the alignment direction of the liquid crystal molecules in the liquid crystal layer 140 is determined by the alignment films 331 and 332, and the position within the pixel region A1 where the impurities IM and IP generated in the liquid crystal layer 140 tend to accumulate is expected, it is preferable that the first peripheral electrode 311 extends along the circumferential direction in the peripheral region A3, which faces, in plan view, the position in the pixel region A1 where the impurities IP tend to accumulate. Similarly, in plan view, it is preferable that the second peripheral electrode 312 extends along the circumferential direction in the peripheral region A3, which faces the position in the pixel region A1 where the impurities IM tend to accumulate.

Although not illustrated, for example, in plan view, the first peripheral electrode 311 and the second peripheral electrode 312 may be disposed in an inverted manner with respect to each other, with reference to an imaginary line (not illustrated) that is parallel to the X direction and the center of the pixel region A1 and the peripheral region A3 in the Y direction. That is, the first peripheral electrode 311 may extend along the X direction in the region A33 of the peripheral region A3, and may extend along the Y direction in portions on the −Y side relative to the center in the Y direction in the regions A32 and A34 of the peripheral region A3. The second peripheral electrode 312 may extend along the X direction in the region A31 of the peripheral region A3, and may extend along the Y direction in portions on the +Y side of the center in the Y direction in each of the regions A32 and A34 of the peripheral region A3.

In addition, the first peripheral electrode 311 and the second peripheral electrode 312 may be separated from each other, in plan view, at central portions in the X direction of each of the regions A31 and A33, in the circumferential direction of the peripheral region A3. That is, the first peripheral electrode 311 may extend along the Y direction in the region A32 of the peripheral region A3, and may extend along the X direction in portions on the +X side relative to the center in the X direction in the regions A31 and A33 of the peripheral region A3. The second peripheral electrode 312 may extend along the Y direction in the region A34 of the peripheral region A3, and may extend along the Y direction in portions on the −X side of the center in the X direction in each of the regions A31 and A33 of the peripheral region A3.

With respect to the relative arrangement of the first peripheral electrode 311 and the second peripheral electrode 312 described above, in plan view, the first peripheral electrode 311 and the second peripheral electrode 312 may be disposed in an inverted manner with respect to each other, with reference to an imaginary line (not illustrated) that is parallel to the Y direction and the center of the pixel region A1 and the peripheral region A3 in the X direction.

FIG. 6 is a cross-sectional view illustrating the movement of the impurities IS in the liquid crystal device 10. As illustrated in FIG. 6, outside the third peripheral electrode 315 of the pixel region A3 in plan view, for example, at least a part of the impurities IS generated from the sealing material 16 actually moves to the third peripheral electrode 315 toward the pixel electrode A1 in plan view. A repulsive effect is exerted on the impurities IS by the third peripheral electrode 315, suppressing their movement into the pixel region A1.

The third peripheral electrode 315 is disposed so as to face the sealing material 16 along the circumferential direction of the peripheral region A3 in plan view, and so as to be interposed between the sealing material 16 and the pixel region A1. As a result, the repulsive effect of the third peripheral electrode 315 can be favorably exerted on the impurities IS from the sealing material 16. Specifically, in plan view, since the sealing material 16 is a sealant that seals the liquid crystal layer 140 from the outside in the XY plane as described above, it is disposed in a frame shape surrounding the entire periphery of the pixel region A1. The third peripheral electrode 315 is disposed in a frame shape surrounding the entire periphery of the pixel region A1 inside the sealing material 16.

### Projector and Electronic Apparatus

Next, a projector as an example of an electronic apparatus including the liquid crystal device 10 according to the first embodiment will be described.

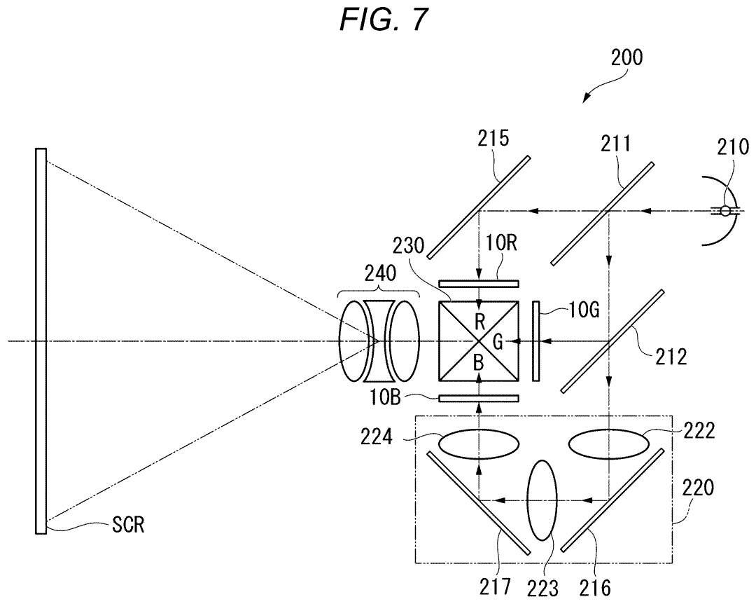

FIG. 7 is a schematic diagram of a projector 200 according to the first embodiment. As illustrated in FIG. 7, the projector 200 is a so-called three-plate projector, and includes a light source device 210, two dichroic mirrors 211 and 212, three total reflection mirrors 215, 216, and 217, three liquid crystal devices 10B, 10G, and 10R, a cross dichroic prism 230, and a projection optical system 240. Each of the liquid crystal devices 10B, 10G, and 10R is formed similarly to the liquid crystal device 10 described above.

The light source device 210 includes a halogen lamp or a white light emitting diode (LED), and emits white light including a red light, a green light, and a blue light. The white light emitted from the light source device 210 is separated into the red light, the green light, and the blue light by the dichroic mirror 211, and is separated into the green light and the blue light by the dichroic mirror 212.

The red light emitted from dichroic mirror 211 is reflected by the total reflection mirror 215 and then irradiates the liquid crystal device 10R. The green light emitted from the dichroic mirror 211 is emitted from the dichroic mirror 212 and irradiates the liquid crystal device 10G. The blue light emitted from the dichroic mirror 211 is reflected by the total reflection mirrors 216 and 217 and then irradiates the liquid crystal device 10B.

The optical path of the blue light from the dichroic mirror 211 to the liquid crystal device 10B is longer than the optical path of the red light from the dichroic mirror 211 to the liquid crystal device 10R and the optical path of the green light from the dichroic mirror 211 to the liquid crystal device 10G. In order to suppress the loss of the blue light with respect to the red light and the green light, an incident lens 222 is disposed on the optical path of the blue light between the dichroic mirror 212 and the total reflection mirror 216. A relay lens 223 is disposed between the total reflection mirror 216 and the total reflection mirror 217. An emission lens 224 is disposed between the total reflection mirror 217 and the liquid crystal device 10B. The incident lens 222, the relay lens 223, and the exit lens 224 form a relay optical system 220.

The liquid crystal device 10R is driven based on an input image signal corresponding to the incident red light, and generates image light R including a red transmission image. The liquid crystal device 10G is driven based on an input image signal corresponding to the incident green light, and generates image light G including a green transmission image. The liquid crystal device 10B is driven based on an input image signal corresponding to the incident blue light, and generates image light B including a blue transmission image.

The image light R emitted from the liquid crystal device 10R, the image light G emitted from the liquid crystal device 10G, and the image light B emitted from the liquid crystal device 10B are incident on a cross dichroic prism 230 from different directions in plan view. In the cross dichroic prism 230, the image lights R and B are reflected, and each optical path of the image lights R and B is refracted by 90° in plan view. In the cross dichroic prism 230, the image light G is transmitted and travels straight, and the optical path of the image light G overlaps the optical paths of the image lights R and B.

The image light combined by the cross dichroic prism 230 and emitted in a direction different from the incident directions of the image lights R, G, and B is enlarged and projected onto the screen SCR by the projection optical system 240. The projection optical system 240 includes one or more optical lenses. Examples of the optical lenses include a biconvex lens, a biconcave lens, a planoconvex lens, a meniscus lens, an aspherical lens, and a freeform lens. A color image is displayed on the screen SCR.

Examples of the electronic apparatuses including the electro optical device such as the liquid crystal device 10 include, in addition to the projector 200, an electronic viewfinder in a head-mounted display, a video camera, a lens-interchangeable digital camera, or the like, a smart watch, and a display unit of a wearable device.

### Effects and Advantages

The liquid crystal device 10 according to the first embodiment described above includes the counter electrode (common electrode) 150, the plurality of pixel electrodes 120, the first peripheral electrode (first electrode) 311, the second peripheral electrode (second electrode) 312, the third peripheral electrode (third electrode) 315, and the liquid crystal layer 140. The potential (common potential) LCcom is applied to the counter electrode 150. The potential (signal potential) LCsig is applied to each of the plurality of pixel electrodes 120. The plurality of pixel electrodes 120 are disposed in the pixel region (display region) A1 in plan view. The potential (first potential) LC1 having a negative polarity with respect to the potential LCcom is applied to the first peripheral electrode 311. The first peripheral electrode 311 is disposed in the peripheral region A3 outside the pixel region A1 in plan view. The potential (second potential) LC2 having a positive polarity with respect to the potential LCcom is applied to the second peripheral electrode 312. The second peripheral electrode 312 is disposed in the peripheral region A3 outside the pixel region A1 in plan view. A potential (third potential) LC3 different from the potential LCcom is applied to the third peripheral electrode 315. The third peripheral electrode 315 is disposed in the peripheral region A3 outside the pixel region A1 in plan view. The liquid crystal layer 140 is disposed between each of the plurality of pixel electrodes 120 and the counter electrode 150, between the first peripheral electrode 311 and the counter electrode 150, between the second peripheral electrode 312 and the counter electrode 150, and between the third peripheral electrode 315 and the counter electrode 150 in the Z direction. In the liquid crystal device 10 according to the first embodiment, in plan view, the distance d3 between the third peripheral electrode 315 and the pixel region A1 is longer than the distance (first distance) d1 between the first peripheral electrode 311 and the pixel region A1 and the distance (second distance) d2 between the second peripheral electrode 312 and the pixel region A1. In the liquid crystal device 10 according to the first embodiment, in plan view, the first peripheral electrode 311 is disposed between the third peripheral electrode 315 and the pixel region A1, and the second peripheral electrode 312 is also disposed between the third peripheral electrode 312 and the pixel region A1.

In the liquid crystal device 10 according to the first embodiment, the impurities IP having a positive polarity generated from the liquid crystal layer 140 in the pixel region A1 are captured by the first peripheral electrode 311 in the energized state, and the impurities IM having a negative polarity generated from the liquid crystal layer 140 in the pixel region A1 are captured by the second peripheral electrode 312 in the energized state. Further, in plan view, the third peripheral electrode 315 repels the impurities IS having a negative polarity generated from the sealing material 16 and the like in the peripheral region A3 outside the first peripheral electrode 311 and the second peripheral electrode 312, thereby preventing the impurities IS from entering the pixel region A1. In the liquid crystal device 10 according to the first embodiment, since the first peripheral electrode 311 and the second peripheral electrode 312 are disposed in accordance with the polarities of the impurities IP and IM, it is possible to enhance the capturing effect of the impurities IP of the first peripheral electrode 311 and the capturing effect of the impurities IM of the second peripheral electrode 312. In the liquid crystal device 10 according to the first embodiment, since the third peripheral electrode 315 is disposed outside the first peripheral electrode 311 and the second peripheral electrode 312 in plan view, the repulsive effect of the impurities IS from the outside of the first peripheral electrode 311 and the second peripheral electrode 312 can be obtained. According to the liquid crystal device 10 of the first embodiment, based on the polarities of the impurities IM, IP, and IS, the impurities IM, IP, and IS can be efficiently and smoothly suppressed from entering the pixel region A1, thereby enhancing display quality and reliability.

In the liquid crystal device 10 according to the first embodiment, the third peripheral electrode 315 is disposed in a frame shape surrounding the entire periphery of the pixel region A1 without a gap in plan view.

In the liquid crystal device 10 according to the first embodiment, since the shape of the third peripheral electrode 315 in plan view is a frame shape, the repulsive effect of the third peripheral electrode 315 on the impurities IS exerts on the entire region in the circumferential direction of the pixel region A1 and the peripheral region A3, and it is possible to suppress the impurities IS from entering the pixel region A1 from the outside of the first peripheral electrode 311 and the second peripheral electrode 312 with high accuracy. According to the liquid crystal device 10 of the first embodiment, it is possible to efficiently and smoothly suppress the impurities IS from entering the pixel region A1, and to enhance display quality and reliability.

The liquid crystal device 10 according to the first embodiment further includes the sealing material (sealant) 16 that is disposed outside the third peripheral electrode 315 in plan view and seals the liquid crystal layer 140.

In the liquid crystal device 10 according to the first embodiment, for example, the impurities IS generated from the sealing material 16 can be suppressed from entering the pixel region A1 with high accuracy.

The electronic apparatus including the projector (electronic apparatus) 200 according to the first embodiment includes the liquid crystal device 10 described above.

According to the projector 200 and the electronic apparatus of the first embodiment, since they include the liquid crystal device 10, the display quality and reliability of the entire projected image can be enhanced.

### Second Embodiment

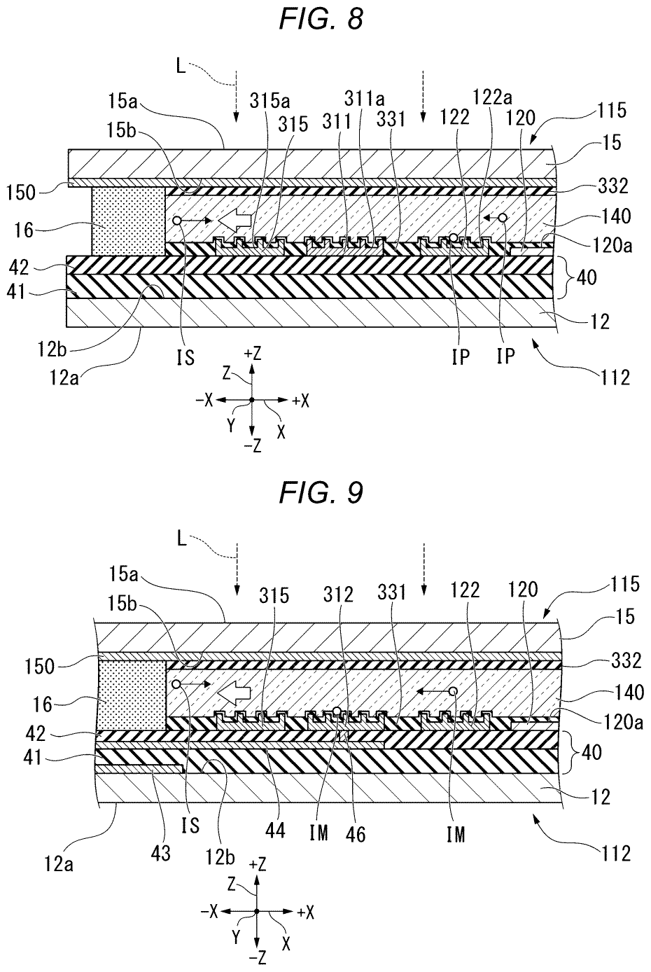

A second embodiment of the present disclosure will next be described with reference to FIGS. 8 and 9. In the description of each of the second and subsequent embodiments, the description of the contents in common with the first embodiment will be omitted, and only contents different from those in the first embodiment will be described. In addition, in the configurations of the liquid crystal devices according to each of the second and subsequent embodiments, the same reference numerals as those of the corresponding configuration in the liquid crystal device 10 according to the first embodiment are given to the configuration common to the liquid crystal device 10 according to the first embodiment, and the detailed description thereof will be omitted.

Although not illustrated, the liquid crystal device according to the second embodiment has the same configuration as the liquid crystal device 10 according to the first embodiment. FIGS. 8 and 9 are cross-sectional views of a range from the pixel region A1 to the peripheral region A3 in plan view of the liquid crystal device according to the second embodiment. FIG. 8 is a cross-sectional view corresponding to the line II-II in FIG. 1 as viewed in the indicated direction. FIG. 9 is a cross-sectional view corresponding to the line III-III in FIG. 1 as viewed in the indicated direction.

As illustrated in FIG. 8, in the liquid crystal device according to the second embodiment, fine unevenness is formed on a surface 122a on the +Z side of each of the plurality of dummy pixel electrodes 122, a surface 311a on the +Z side of the first peripheral electrode 311, and a surface 315a of the third peripheral electrode 315. The width in the X direction, the width in the Y direction, and the depth in the Z direction of the unevenness formed in the first peripheral electrode 311 are appropriately larger than the maximum diameter of the impurities IP.

Since the unevenness is formed in the first peripheral electrode 311 in the Z direction, the impurities IP generated in the liquid crystal layer 140 and moving toward the first peripheral electrode 311 enter the recesses of the unevenness, the impurities IP are actively captured by the first peripheral electrode 311, and the capturing effect of the impurities IP in the first peripheral electrode 311 in the energized state and the non-energized state is improved.

The first peripheral electrode 311 is formed higher than at least each of the plurality of pixel electrodes 120. That is, the end surface on the +Z side of the first peripheral electrode 311 is located further on the +Z side than the surface 120a on the +Z side of each of the plurality of pixel electrodes 120. The end surface of the first peripheral electrode 311 on the +Z side is a convex surface of the unevenness formed on the first peripheral electrode 311 and means a surface closest to the +Z side in the first peripheral electrode 311 and along the XY plane. The shortest distance between the end surface of the first peripheral electrode 311 on the +Z side and the surface of the counter electrode 150 on the −Z side is shorter than the shortest distance between the surface 120a of each of the plurality of pixel electrodes 120 on the +Z side and the surface of the counter electrode 150 on the −Z side.

Since the first peripheral electrode 311 is formed higher than each of the plurality of pixel electrodes 120, the impurities IP generated in the liquid crystal layer 140 of the pixel region A1 are more likely to move toward the first peripheral electrode 311 in the XY plane, and less likely to move toward the pixel electrodes 120 after being captured by the first peripheral electrode 311, which improves the capturing effect of the impurities IP in the first peripheral electrode 311 in both the energized and non-energized states.

Since the unevenness is formed in the third peripheral electrode 315 in the Z direction, the diffusion speed of the impurities IS diffusing from the sealing material 16 can be reduced, and the entering of the impurities IS into the pixel region A1 can be efficiently suppressed.

The third peripheral electrode 315 is formed higher than at least each of the plurality of pixel electrodes 120. That is, the end surface on the +Z side of the third peripheral electrode 315 is located further on the +Z side than the surface 120a on the +Z side of each of the plurality of pixel electrodes 120. The end surface of the third peripheral electrode 315 on the +Z side is a convex surface of the unevenness formed on the third peripheral electrode 315, and means a surface closest to the +Z side in the third peripheral electrode 315 and along the XY plane. The shortest distance between the end surface of the third peripheral electrode 315 on the +Z side and the surface of the counter electrode 150 on the −Z side is shorter than the shortest distance between the surface 120a of each of the plurality of pixel electrodes 120 on the +Z side and the surface of the counter electrode 150 on the −Z side.

Since the third peripheral electrode 315 is formed higher than each of the plurality of pixel electrodes 120, it exerts a physical barrier effect on the impurities IS, making it less likely for the impurities IS generated from the sealing material 16 or the like in the peripheral region A3 to move toward the first peripheral electrode 311 or the plurality of pixel electrodes 120 in the pixel region A1 on the XY plane, and thereby improving the repulsive effect of the third peripheral electrode 315 on the impurities IS in both the energized and non-energized states.

As illustrated in FIG. 9, in the liquid crystal device according to the second embodiment, fine unevenness is formed on a surface 312a on the +Z side of the second peripheral electrode 312. The width in the X direction, the width in the Y direction, and the depth in the Z direction of the unevenness formed in the second peripheral electrode 312 are appropriately larger than the maximum diameter of the impurities IM. Since the unevenness is formed in the second peripheral electrode 312 in the Z direction, the impurities IM generated in the liquid crystal layer 140 and moving toward the second peripheral electrode 312 enter the recesses of the unevenness, the impurities IM are actively captured by the second peripheral electrode 312, and the capturing effect of the impurities IM in the second peripheral electrode 312 in the energized state and the non-energized state is improved.

The second peripheral electrode 312 is formed higher than at least each of the plurality of pixel electrodes 120, and is formed, for example, at the same level as the first peripheral electrode 311. The end surface on the +Z side of the second peripheral electrode 312 is located further on the +Z side than the surface 120a of each of the plurality of pixel electrodes 120. The end surface of the second peripheral electrode 312 on the +Z side is a convex surface of the unevenness formed on the second peripheral electrode 312, and means a surface closest to the +Z side in the second peripheral electrode 312 and along the XY plane. The shortest distance between the end surface of the second peripheral electrode 312 on the +Z side and the surface of the counter electrode 150 on the −Z side is shorter than the shortest distance between the surface 120a of each of the plurality of pixel electrodes 120 and the surface of the counter electrode 150 on the −Z side.

Since the second peripheral electrode 312 is formed higher than each of the plurality of pixel electrodes 120, the impurities IM generated in the liquid crystal layer 140 of the pixel region A1 are more likely to move toward the second peripheral electrode 312 in the XY plane, and less likely to move toward the pixel electrode 120 after being captured by the second peripheral electrode 312, which improves the capturing effect of the impurities IM in the second peripheral electrode 312 in the energized state and the non-energized state.

In the liquid crystal device according to the second embodiment, the capturing effect of the first peripheral electrode 311 on the impurities IP, the capturing effect of the second peripheral electrode 312 on the impurities IM, and the repulsive effect of the third peripheral electrode 315 on the impurities IS are improved, and as compared with a case where the +Z side surface of each of the first peripheral electrode 311, the second peripheral electrode 312, and the third peripheral electrode 315 is flat without unevenness formed on the +Z side surface, display unevenness due to the impurities formed from ionic substances in the pixel region A1 is suppressed, and display quality and reliability are improved.

Fine unevenness similar to that of the first peripheral electrode 311 or the second peripheral electrode 312 is formed on the +Z side surface 122a of the dummy pixel electrode 122. The dummy pixel electrode 122 is formed on least higher than each of the plurality of pixel electrodes 120, and is formed on the same level as the first peripheral electrode 311 and the second peripheral electrode 312.

For example, the impurities IP that cannot be captured by the first peripheral electrode 311 in the energized state and the impurities IM that cannot be captured by the second peripheral electrode 312 in the energized state can be captured by the unevenness of the dummy pixel electrode 122 in the energized state. In addition, when the impurities IP diffusing from the first peripheral electrode 311 in the non-energized state toward the pixel electrode 120 and the impurities IM diffusing from the second peripheral electrode 312 in the non-energized state toward the pixel electrode 120 are present, these impurities IM and IP can be captured by the unevenness of the dummy pixel electrode 122 in the non-energized state.

In the liquid crystal device according to the second embodiment, as long as either the capturing effect on the impurities IP of the first peripheral electrode 311 in which the unevenness is not formed, or the capturing effect on the impurities IM of the second peripheral electrode 312 in which the unevenness is not formed, is satisfactorily secured, the unevenness may be formed only in the other peripheral electrode. The first peripheral electrode 311, the second peripheral electrode 312, and the dummy pixel electrode 122 may be formed without the unevenness, as long as both the capturing effect on the impurities IP by the first peripheral electrode 311 in which the unevenness is not formed, and the capturing effect on the impurities IM by the second peripheral electrode 312 in which the unevenness is not formed, are ensured. The dummy pixel electrode 122 may be formed without the unevenness, as long as the capturing effect on the impurities IP by the first peripheral electrode 311 in which the unevenness is formed, and the capturing effect on the impurities IM by the second peripheral electrode 312 in which the unevenness is formed, are sufficiently ensured.

The liquid crystal device according to the second embodiment described above includes the same components as those of the liquid crystal device 10 according to the first embodiment and exhibits the same effects as described above for the liquid crystal device 10.

In the liquid crystal device according to the second embodiment, unevenness is formed on a surface (surface) 315a of the third peripheral electrode (third electrode) 315 on the liquid crystal layer 140 side.

According to the liquid crystal device of the second embodiment, since the surface area of the third peripheral electrode 315 on the liquid crystal layer 140 side increases due to the unevenness, it is possible to enhance the diffusion prevention effect of the third peripheral electrode 315 on the impurities IS, to efficiently and smoothly suppress the impurities IS from entering the pixel region A1, and to further enhance display quality and reliability.

In the liquid crystal device according to the second embodiment, the third peripheral electrode 315 is formed higher on the +Z side than each of the plurality of pixel electrodes 120, and is closer to the counter electrode 150 in the Z direction than each of the plurality of pixel electrodes 120.

According to the liquid crystal device of the second embodiment, it is possible to enhance the repulsive effect of the third peripheral electrode 315 on the impurities IS in the energized and non-energized states, to efficiently suppress the impurities IS from entering the pixel region A1, to suppress the diffusion of the impurities IS into the pixel region A1, and to further enhance display quality and reliability.

In the liquid crystal device according to the second embodiment, unevenness is formed on a surface (surface) 311a of the first peripheral electrode (first electrode) 311 on the liquid crystal layer 140 side.

According to the liquid crystal device of the second embodiment, since the impurities IP generated in the liquid crystal layer 140 are actively captured in the unevenness of the first peripheral electrode 311, the capturing effect of the first peripheral electrode 311 on the impurities IP can be enhanced, the impurities IP can be efficiently and smoothly removed from the pixel region A1, thereby further enhancing display quality and reliability.

In the liquid crystal device according to the second embodiment, unevenness is formed on a surface (surface) 312a of the second peripheral electrode (second electrode) 312 on the liquid crystal layer 140 side.

According to the liquid crystal device of the second embodiment, since the impurities IM generated in the liquid crystal layer 140 are actively captured in the unevenness of the second peripheral electrode 312, the capturing effect of the second peripheral electrode 312 on the impurities IM can be enhanced, the impurities IM can be efficiently and smoothly removed from the pixel region A1, thereby further enhancing display quality and reliability.

In the liquid crystal device according to the second embodiment, the first peripheral electrode 311 is formed higher on the +Z side than each of the plurality of pixel electrodes 120, and is closer to the counter electrode 150 in the Z direction than each of the plurality of pixel electrodes 120.

According to the liquid crystal device of the second embodiment, it is possible to enhance the capturing effect of the first peripheral electrode 311 on the impurities IP in the energized and non-energized states, to efficiently remove the impurities IM from the pixel region A1, to suppress the diffusion of the impurities IM into the pixel region A1, and to further enhance display quality and reliability.

In the liquid crystal device according to the second embodiment, the second peripheral electrode 312 is formed higher on the +Z side than each of the plurality of pixel electrodes 120, and is closer to the counter electrode 150 in the Z direction than each of the plurality of pixel electrodes 120.

According to the liquid crystal device of the second embodiment, it is possible to enhance the capturing effect of the second peripheral electrode 312 on the impurities IM in the energized and non-energized states, to efficiently remove the impurities IP from the pixel region A1, to suppress the diffusion of the impurities IP into the pixel region A1, and to further enhance display quality and reliability.

Although not illustrated, the projector (electronic apparatus) according to the second embodiment includes the same components as those of the projector 200 according to the first embodiment. In the projector according to the second embodiment, each of the three liquid crystal devices 10B, 10G, and 10R of the projector 200 according to the first embodiment is formed similarly to the liquid crystal device according to the second embodiment described above.

According to the projector and the electronic apparatus of the second embodiment, since they include the liquid crystal device according to the second embodiment, the display quality and reliability of the entire projected image can be further enhanced.

### Third Embodiment

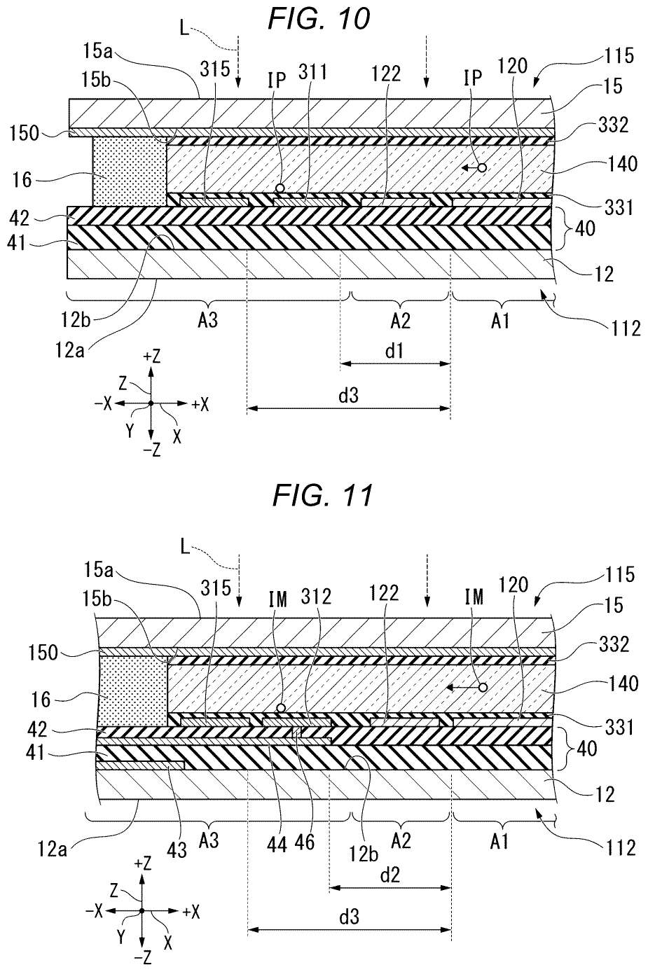

Next, a third embodiment of the present disclosure will next be described with reference to FIGS. 10 and 11. Although not illustrated, the liquid crystal device according to the third embodiment has the same configuration as the liquid crystal device 10 according to the first embodiment. FIGS. 10 and 11 are cross-sectional views of a range from the pixel region A1 to the peripheral region A3 in plan view of the liquid crystal device according to the third embodiment. FIG. 10 is a cross-sectional view corresponding to the line II-II in FIG. 1 as viewed in the indicated direction. FIG. 11 is a cross-sectional view corresponding to the line III-III in FIG. 1 as viewed in the indicated direction.

In the liquid crystal device according to a third embodiment, the distance d1 is shorter than the distance d2. That is, the distance between the first peripheral electrode 311 and the pixel region A1 is at least shorter than the distance between the second peripheral electrode 312 and the pixel region A1, and the first distance is at least shorter than the second distance. The ratio between the distance d1 and the distance d2 is appropriately set in accordance with the ratio between the moving speed and the diffusion speed of the impurities IM and IP.

The impurities IP generated from the liquid crystal layer 140 in the pixel region A1 are captured by the first peripheral electrode 311, while the impurities IM generated from the liquid crystal layer 140 in the pixel region A1 are captured by the second peripheral electrode 312. Since the moving speed of the impurities IP is slower than that of the impurities IM, the impurities IP are captured by the first peripheral electrode 311 disposed relatively close to the pixel region A1, and the capturing effect of the first peripheral electrode 311 in the energized state, that is, in the state where the potential LC1 is applied is enhanced. Since the moving speed of the impurities IM is faster than that of the impurities IP, the impurities IM are captured by the second peripheral electrode 312 disposed relatively far from the pixel region A1.

The diffusion speed of the impurities IM having a relatively high moving speed is faster than the diffusion speed of the impurities IP. Before and after the first peripheral electrode 311 is energized, that is, in a non-energized state, the capturing effect of the first peripheral electrode 311 on the impurities IP is weakened, and the impurities IP diffuse from the first peripheral electrode 311 in the XY plane. Similarly, before and after the second peripheral electrode 312 is energized, that is, in a non-energized state, the capturing effect of the second peripheral electrode 312 on the impurities IM is weakened, and the impurities IM diffuse from the second peripheral electrode 312 in the XY plane. Although the diffusion speed of the impurities IM is higher than that of the impurities IP, since the second peripheral electrode 312 is disposed farther from the pixel region A1 than the first peripheral electrode 311, the return of the impurities IM from the second peripheral electrode 312 to the pixel region A1 in the non-energized state is suppressed.

In the liquid crystal device according to the third embodiment, the impurities IP with a low moving speed generated in the liquid crystal layer 140 of the pixel region A1 are captured by the first peripheral electrode 311 in the energized state disposed close to the pixel region A1, while the impurities IM with a high moving speed generated in the liquid crystal layer 140 are captured by the second peripheral electrode 312 in the energized state disposed farther from the pixel region A1, thereby suppressing the diffusion of the impurities IM from the second peripheral electrode 312 in the non-energized state to the pixel region A1, preventing the formation of display spots at the outer peripheral end of the pixel region A1 and suppressing the decrease in light amount of the image light emitted from the pixel region A1. As a result, the display quality and reliability of the liquid crystal device 10 are improved.

The liquid crystal device according to the third embodiment described above includes the same components as those of the liquid crystal device 10 according to the first embodiment and exhibits the same effects as described above for the liquid crystal device 10.

In the liquid crystal device according to the third embodiment, in plan view, the distance d1 between the first peripheral electrode 311 and the pixel region A1 is shorter than the distance d2 between the second peripheral electrode 312 and the pixel region A1.

In the liquid crystal device according to the third embodiment, the impurities IP having a relatively low moving speed and positive polarity are captured by the first peripheral electrode 311 in the energized state disposed relatively close to the pixel region A1, and the impurities IM having a relatively high moving speed and negative polarity are captured by the second peripheral electrode 312 in the energized state disposed relatively far from the pixel region A1. In the liquid crystal device 10 according to the first embodiment, since the first peripheral electrode 311 and the second peripheral electrode 312 are disposed in accordance with the polarities and moving speed of the impurities IP and IM, it is possible to enhance the capturing effect of the impurities IP of the first peripheral electrode 311 and the capturing effect of the impurities IM of the second peripheral electrode 312. According to the liquid crystal device 10 of the first embodiment, based on the polarities of the impurities IP and IM, the impurities IP and IM can be efficiently and smoothly removed from pixel region A1, thereby enhancing display quality and reliability.

In the liquid crystal device 10 according to the third embodiment, the impurities IM whose diffusion speed is faster than that of the impurities IP in accordance with the moving speed are captured by the second peripheral electrode 312 disposed farther from the pixel region A1 than the first peripheral electrode 311. According to the liquid crystal device 10 of the third embodiment, based on the polarities of the impurities IP and IM, the impurities IM from the first peripheral electrode 311 in the non-energized state and the impurities IP from the second peripheral electrode 312 in the non-energized state can be suppressed from entering the pixel region A1, thereby enhancing display quality and reliability.

In the liquid crystal device according to the third embodiment, as described in the second embodiment, fine unevenness may be formed on the +Z side surface of at least one of the dummy pixel electrode 122, the first peripheral electrode 311, the second peripheral electrode 312, and the third peripheral electrode 315.

Although not illustrated, the projector (electronic apparatus) according to the third embodiment includes the same components as those of the projector 200 according to the first embodiment. In the projector according to the third embodiment, each of the three liquid crystal devices 10B, 10G, and 10R of the projector 200 according to the first embodiment is formed similarly to the liquid crystal device according to the third embodiment described above.

According to the projector and the electronic apparatus of the third embodiment, since they include the liquid crystal device according to the third embodiment, the display quality and reliability of the entire projected image can be further enhanced.

A preferable embodiment of the present disclosure has been described above in detail. The present disclosure is, however, not limited to the specific embodiment, and various modifications and changes can be made thereto within the scope of the key points of the present disclosure disclosed in the claims.

For example, in the cross-sectional view of the liquid crystal device or the like, the stacked structure including the conductive layer, semiconductor layer, or insulating layer within each of the element substrate 12 and the counter substrate 15 is omitted, and an example of the conductive layer is illustrated. A conductive layer, a semiconductor layer, or an insulating layer (not illustrated), for wiring or interlayer spacing, may be provided between the +Z side surface of the element substrate 12 and at least one of the pixel electrode 120, the dummy pixel electrode 122, the first peripheral electrode 311, and the second peripheral electrode 312. The −Z side surface of at least one of the pixel electrode 120, the dummy pixel electrode 122, the first peripheral electrode 311, and the second peripheral electrode 312 may not be a flat surface.

### SUMMARY OF PRESENT DISCLOSURE

The summary of the present disclosure will be appended below.

(Appendix 1) A liquid crystal device includes: a common electrode to which a common potential is applied, a plurality of pixel electrodes, each of which is applied with a signal potential and disposed in a display region, a first electrode to which a first potential having a negative polarity with respect to the common potential is applied and which is disposed outside the display region in plan view, a second electrode to which a second potential having a positive polarity with respect to the common potential is applied and which is disposed outside the display region in plan view, a third electrode to which a third potential different from the common potential is applied and which is disposed outside the display region in plan view, and a liquid crystal layer disposed between each of the plurality of pixel electrodes and the common electrode, between the first electrode and the common electrode, between the second electrode and the common electrode, and between the third electrode and the common electrode, wherein, in plan view, the distance between the third electrode and the display region is longer than a first distance between the first electrode and the display region and a second distance between the second electrode and the display region, and in plan view, the first electrode is disposed between the third electrode and the display region, and the second electrode is disposed between the third electrode and the display region.

According to the configuration of Appendix 1, when converting the color light into the image light, the impurities generated in the liquid crystal layer and having a positive polarity are captured by the first electrode in the energized state, the impurities having a negative polarity are captured by the second electrode in the energized state, and the impurities generated in the region outside the first electrode and the second electrode in plan view and moving toward the display region are repelled outward the outside in plan view by the third electrode in the energized state. As a result, the capturing effect of the first electrode on the impurities having the positive polarity, the capturing effect of the second electrode on the impurities having the negative polarity, and the repulsive effect of the third electrode on the impurities can be enhanced as compared with the related art, the impurities can be efficiently and smoothly removed from the display region based on the polarity of the impurities, and the display quality and reliability can be enhanced.

(Appendix 2) The liquid crystal device according to Appendix 1, wherein the third electrode is disposed in a frame shape surrounding the entire periphery of the display region in plan view.

According to the configuration of Appendix 2, the repulsive effect of the third electrode on the impurities is exerted on the entire periphery of the display region, thereby suppressing impurities from entering the display region from outside of the first electrode and the second electrode in plan view.

(Appendix 3) The liquid crystal device according to Appendix 1 or 2, including a sealant disposed outside the third electrode in plan view, the sealant sealing the liquid crystal layer.

With the configuration of Appendix 3, impurities generated from the sealant can be suppressed from entering the display region.

(Appendix 4) The liquid crystal device according to any one of Appendices 1 to 3, wherein unevenness is formed on the surface of the third electrode on the liquid crystal layer side.

According to the configuration of Appendix 4, it is possible to reduce the diffusion speed of impurities diffused from the sealant or the like disposed on the outer peripheral side of the third electrode, and to efficiently suppress intrusion into the display region.

(Appendix 5) The liquid crystal device according to any one of Appendices 1 to 4, wherein the third electrode is higher than each of the plurality of pixel electrodes.

According to the configuration of Appendix 5, impurities generated outside the third electrode in plan view are less likely to move through the third electrode toward the plurality of pixel electrodes in the display region, and the repulsive effect on the impurities of the third electrode can be reinforced.

(Appendix 6) The liquid crystal device according to any one of Appendices 1 to 5, wherein unevenness is formed on the surface of the first electrode on the liquid crystal layer side.

According to the configuration of Appendix 6, the impurities having a positive polarity are actively captured by the unevenness formed on the first electrode, and the capturing effect on the impurities having a positive polarity of the first electrode can be enhanced.

(Appendix 7) The liquid crystal device according to any one of Appendices 1 to 6, wherein unevenness is formed on the surface of the second electrode on the liquid crystal layer side.

According to the configuration of Appendix 7, the impurities having a negative polarity are actively captured by the unevenness formed on the second electrode, and the capturing effect on the impurities having a negative polarity of the second electrode can be enhanced.

(Appendix 8) The liquid crystal device according to any one of Appendices 1 to 7, wherein the first electrode is higher than each of the plurality of pixel electrodes.

According to the configuration of Appendix 8, the impurities having a positive polarity are more likely to move toward the first electrode in the energized state, and the impurities having a positive polarity are less likely to move from the first electrode in the non-energized state toward the pixel electrode, thereby enhancing the capturing effect of the first electrode on the impurities having a positive polarity.

(Appendix 9) The liquid crystal device according to any one of Appendices 1 to 8, wherein the second electrode is higher than each of the plurality of pixel electrodes.

According to the configuration of Appendix 9, the impurities having a negative polarity are more likely to move toward the second electrode in the energized state, and the impurities having a negative polarity are less likely to move from the second electrode in the non-energized state toward the pixel electrode, thereby enhancing the capturing effect of the second electrode on the impurities having a negative polarity.

(Appendix 10) The liquid crystal device according to any one of Appendices 1 to 9, wherein the first distance is shorter than the second distance in plan view.

According to the configuration of Appendix 10, the impurities having a positive polarity and a relatively low moving speed generated in the liquid crystal layer are captured by the first electrode in the energized state, which is disposed relatively close to the display region, and the impurities having a negative polarity and a relatively high moving speed are captured by the second electrode in the energized state, which is disposed relatively far from the pixel region. As a result, the capturing effect of the first electrode on the impurities having the positive polarity and the capturing effect of the second electrode on the impurities having a negative polarity can be enhanced as compared with the related art, the impurities can be efficiently and smoothly removed from the display region based on the polarity of the impurities, and the display quality and reliability can be enhanced.

(Appendix 11) An electronic apparatus including the liquid crystal device according to any one of Appendices 1 to 10.

According to the configuration of Appendix 11, the display quality of the output image of the electronic apparatus and the reliability of the electronic apparatus can be enhanced.

What is claimed is:

1. A liquid crystal device comprising:
a common electrode to which a common potential is applied,
a pixel electrode, which is applied with a signal potential and disposed in a display region,
a first electrode to which a first potential having a negative polarity with respect to the common potential is applied and which is disposed outside the display region in plan view,
a second electrode to which a second potential having a positive polarity with respect to the common potential is applied and which is disposed outside the display region in plan view,
a third electrode to which a third potential different from the common potential is applied and which is disposed outside the display region in plan view, and
a liquid crystal layer disposed between the pixel electrode and the common electrode, between the first electrode and the common electrode, between the second electrode and the common electrode, and between the third electrode and the common electrode,
wherein, in plan view, a distance between the third electrode and the display region is longer than a first distance between the first electrode and the display region and a second distance between the second electrode and the display region, and in plan view, the first electrode is disposed between the third electrode and the display region, and the second electrode is disposed between the third electrode and the display region.

2. The liquid crystal device according to claim 1, wherein the first electrode comprises a first portion extending in a first direction along the display region and a second portion extending from the first portion in a second direction intersecting the first direction along the display region in plan view, and
wherein the second electrode comprises a third portion extending in the first direction along the display region so as to sandwich the display region with the first electrode and a fourth portion extending from the third portion in a third direction opposite to the second direction along the display region in plan view.

3. The liquid crystal device according to claim 1, wherein the third electrode is disposed in a frame shape surrounding an entire periphery of the display region in plan view.

4. The liquid crystal device according to claim 1, comprising a sealant disposed outside the third electrode in plan view, the sealant sealing the liquid crystal layer.

5. The liquid crystal device according to claim 1, wherein unevenness is formed on a surface of the third electrode on the liquid crystal layer side.

6. The liquid crystal device according to claim 1, wherein the third electrode is higher than the pixel electrode.

7. The liquid crystal device according to claim 1, wherein unevenness is formed on a surface of the first electrode on the liquid crystal layer side.

8. The liquid crystal device according to claim 1, wherein unevenness is formed on a surface of the second electrode on the liquid crystal layer side.

9. The liquid crystal device according to claim 1, wherein the first electrode is higher than the pixel electrode.

10. The liquid crystal device according to claim 1, wherein the second electrode is higher than the pixel electrode.

11. The liquid crystal device according to claim 1, wherein the first distance is shorter than the second distance in plan view.

12. An electronic apparatus comprising the liquid crystal device according to claim 1.
